(19) United States
(12) Patent Application Publication
(10) Pub. No.: US 2013/0215092 A1
(43) Pub. Date: Aug. 22, 2013

(54) OLED PANEL AND METHOD FOR DRIVING THE SAME

(71) Applicants: Zhongyuan Wu, Beijing (CN); Tian Xiao, Beijing (CN); Gang Wang, Beijing (CN)

(72) Inventors: Zhongyuan Wu, Beijing (CN); Tian Xiao, Beijing (CN); Gang Wang, Beijing (CN)

(73) Assignee: BOE TECHNOLOGY GROUP CO., LTD., Beijing (CN)

(21) Appl. No.: 13/805,042

(22) PCT Filed: Aug. 23, 2012
(86) PCT No.: PCT/CN12/80519

§ 371 Date: Dec. 18, 2012

(30) Foreign Application Priority Data
Sep. 9, 2011 (CN) 201110268207.3

(51) Int. Cl. G09G 3/32

(52) U.S. Cl. CPC G09G 3/3225
USPC 345/206; 345/80

(57) ABSTRACT

The present invention discloses an OLED panel for improving the hysteresis effect of TFT without increasing the area of the pixel circuit and at the same time ensuring the opening ratio. Said OLED panel includes a substrate and a pixel unit array formed thereon, the pixel unit array comprises a plurality of pixel units defined by the intersections of scanning lines and data lines, and each unit includes a driving TFT and an OLED, and the driving TFT has a source connected to a high voltage signal terminal in a backboard, a drain connected to an anode of the OLED; a plurality of resetting TFTs is arranged in the peripheral area of the pixel unit array on the substrate, and the resetting TFT has a gate connected a pre-controlling signal terminal, a source connected to a resetting signal terminal, and each resetting TFT corresponds to a data line one-to-one.

### TECHNICAL FIELD

The present invention relates to the art of electronics and optics, in particular, to an OLED panel and a method for driving the same.

### BACKGROUND

As illustrated in FIG. 1, a progressive scanning method is generally employed in an Active Matrix Organic Light-Emitting Diode (AMOLED) Display, wherein the gate transistors on each row connected to a scanning line are sequentially turned on by a signal at the scanning line, the respective gate transistors transmit a voltage at a data line to a driving transistor connected to the gate transistor, and the driving transistor converts the voltage into a current and drives an Organic Light-Emitting Diode (OLED), wherein the gate transistor and driving transistor are all Thin Film Transistors (TFT).

The Active Matrix OLED display requires the driving transistor to ensure the stability of the output current, i.e., in the condition of the same gate voltage, the driving current output from the driving transistor in a pixel circuit can maintain consistency over the time and uniformity in the space. Nevertheless, the transfer characteristic of the gate voltage of the TFT during a transition from a positive voltage to a negative voltage (i.e., a positive scanning) is different from that during a transition from a negative voltage to a positive voltage (i.e., a negative scanning). In general, the transfer characteristic curve obtained from the negative scanning is less than that from the positive scanning in the threshold voltage, and the sub-threshold swing resulting from the negative scanning is lower than that from the positive scanning. This phenomenon is referred to as the hysteresis effect of the TFT. The hysteresis effect of the TFT often leads to the inconsistency of the driving current over the time, and thus results in a residual image when the AMOLED displays an image. For example, when a an image of black-and-white chessboard pattern (as shown in FIG. 2A) has been displayed for a certain duration, e.g. 9 s, and then an image of intermediate grayscale (as shown in FIG. 2C) is intended to be displayed; however, an image with a residual image of chessboard pattern is actually obtained (as shown in FIG. 2B). As seen from the FIG. 2B, the color of the black area in the image of the chessboard pattern, in the image of intermediate grayscale, is slightly lighter than the color of the ideal grayscale, and the color of the white area in the image of the chessboard pattern, in the image of intermediate grayscale, is slightly darker than that of the ideal grayscale. Only after the residual image remains a certain time, usually 30 s, the image restores to the status of the ideal grayscale.

In order to reduce the hysteresis effect of the TFT, a HF (hydrofluoric acid) processing, an ultraviolet radiation processing, a H2 plasma processing and the like are mainly applied to the interface in the technical processing. These three methods can improve the hysteresis effect to some extent, but increases the complexities in the technical processing, and the effect achieved is not perfect. To avoid the disadvantages due to the improvements on the technical processing of the TFT, in the prior art, a designing method of adding a resetting transistor to each pixel unit in a pixel circuit is adopted. As shown in FIGS. 3A and 3B, a clock signal for controlling the resetting transistor (Filed Effect Transistor (FET) T3 in FIG. 3A and FET T2 in FIG. 3B) switches on the resetting transistor before a switching transistor T1 in the pixel circuit turns on, to reset the gate voltage of a driving transistor (FET T2 in FIG. 3A and FET T3 in FIG. 3B) in the pixel circuit to a low level (usually GND), and after that, a signal at the data line is applied to the gate of the driving transistor as the switching transistor T1 turns on, and thus the variation in the current of the driving transistor is always in one direction. The above driving mode can improve the hysteresis effect of the TFT, but since one transistor is added to each pixel unit, the area is increased, and the aperture ratio is reduced, and furthermore, the resetting control signal distributed in the pixel area generates the crosstalk to the nodes inside the pixel circuit.

### SUMMARY

The embodiments of the invention provide an OLED panel and a method for driving the same, for improving the hysteresis effect of TFT without increasing the area of the pixel circuit and at the same time ensuring the aperture ratio, and simple in the technical processing.

An Organic light-Emitting Diode OLED panel includes a substrate and a pixel unit array formed thereon, wherein the pixel unit array comprises scanning lines, data lines and pixel units, and each of the pixel units includes a driving Thin Film Transistor TFT and an OLED, and the driving TFT has a source connected to a high voltage signal terminal in a backboard, and a drain connected to an anode of the OLED; the pixel unit further includes resetting TFTs and multiplexing TFTs, wherein the resetting TFT has a gate connected a pre-controlling signal terminal, and a source connected to a resetting signal terminal, and each of the resetting TFTs corresponds to the data line one-to-one; the multiplexing TFT has a gate connected to a gate controlling signal terminal, a source connected to a data voltage signal terminal, and a drain connected to the data line.

A method for driving the OLED panel, comprises the steps of:

outputting scanning voltage and turning on the switching TFT by scanning the pixel unit array from line to line by the scanning line;

transmitting a received resetting signal to the switching TFT by the resetting TFT;

transmitting the received resetting signal to the driving TFT by the switching TFT;

transmitting a received data voltage signal to the switching TFT by the multiplexing TFT;

transmitting the received data voltage signal to the driving TFT by the switching TFT;

driving the OLED by the driving TFT.

An OLED panel comprises a substrate and a pixel unit array formed thereon, wherein the pixel unit array comprises pixel units defined by the intersections of scanning lines and data lines, and each of the pixel units includes a driving TFT and an OLED, and the driving TFT has a source connected to a high voltage signal terminal in a backboard, a drain connected to an anode of the OLED; the each of the pixel units further includes multiplexing TFTs, wherein every n multiplexing TFTs constitute a multiplexer, and the multiplexer is connected to the data voltage signal terminal and the data lines; wherein, the sources of n multiplexing TFTs are connected together, the drains thereof are connected to different data lines respectively, and the gates thereof are connected to different gate controlling signal terminals; n does not exceed the number of the multiplexing TFTs included in the pixel unit array.

A method for driving the OLED panel, comprises the steps of:

outputting the scanning voltage and turning on the switching TFT by scanning the pixel unit array from line to line by the scanning line;

transmitting a received data voltage signal to the switching TFT by the multiplexing TFT; wherein every n multiplexing TFTs constitute a multiplexer, and the multiplexer is connected to the data voltage signal terminal and the data lines respectively; wherein, the sources of n multiplexing TFTs are connected, the drains thereof are connected to different data lines respectively, and the gates thereof are connected to different gate controlling signal terminals; n does not exceed the number of the multiplexing TFTs included in the pixel unit array;

transmitting the received data voltage signal to the driving TFT by the switching TFT; and

driving the OLED by the driving TFT.

According to the embodiments of the present invention, the scanning line outputs a scanning voltage and turns on a switching TFT by scanning a pixel unit array from line to line; a resetting TFT transmits a received resetting signal to the switching TFT; the switching TFT transmits the received resetting signal to a driving TFT; a multiplexing TFT transmits a received data voltage signal to the switching TFT; the switching TFT transmits the received data voltage signal to the driving TFT; and the driving TFT drives an OLED. A uniform voltage is input to the gate of the driving TFT by the resetting signal, which ensures the voltage to vary in the same direction each time the data voltage signal is written to the gate of the driving TFT, and avoids the occurrence of the residual image due to the hysteresis effect of the TFT.

### BRIEF DESCRIPTION OF THE DRAWINGS

FIG. 1 shows a pixel unit array in an active matrix OLED display in the prior art;

FIG. 2A shows an image of original black-and-white chessboard pattern;

FIG. 2B shows an actual image obtained when displaying an image of intermediate grayscale after an image of chessboard pattern is displayed;

FIG. 2C shows an original image of intermediate grayscale;

FIG. 3A shows an equivalent circuit of a single pixel unit in the prior art;

FIG. 3B shows an equivalent circuit of another single pixel unit in the prior art;

FIG. 4A is a diagram of main structure of an OLED panel in an embodiment of the present invention;

FIG. 4B shows an equivalent circuit of a single pixel unit in a pixel unit array of an embodiment of the present invention;

FIG. 4C illustrates a pixel unit array and a timing diagram thereof when data lines in an OLED panel are equal to data voltage signal terminals in number in an embodiment of the present invention;

FIG. 4D illustrates a pixel unit array when data lines in an OLED panel are unequal to data voltage signal terminals in number in an embodiment of the present invention;

FIG. 4E shows a timing in control of a pixel unit array after a MUX multiplexer is employed in an embodiment of the present invention;

FIG. 5 shows a diagram of detailed structure of an OLED panel of an embodiment of the present invention;

FIG. 6A shows a diagram of main structure of another OLED panel of an embodiment of the present invention;

FIG. 6B shows a diagram of detailed structure of another OLED panel of an embodiment of the present invention;

FIG. 7 shows a main flowchart of a method for driving an OLED panel in an embodiment of the present invention; and

FIG. 8 shows a main flowchart of another method for driving another OLED panel in an embodiment of the present invention.

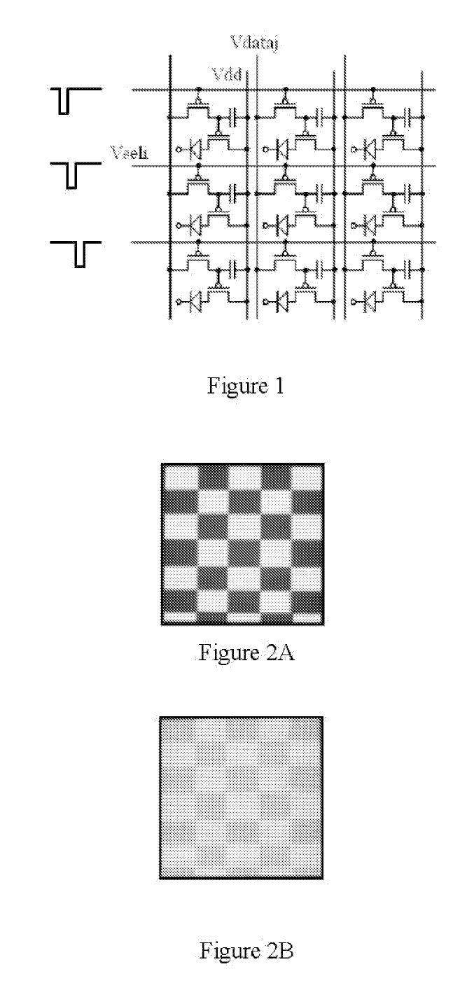

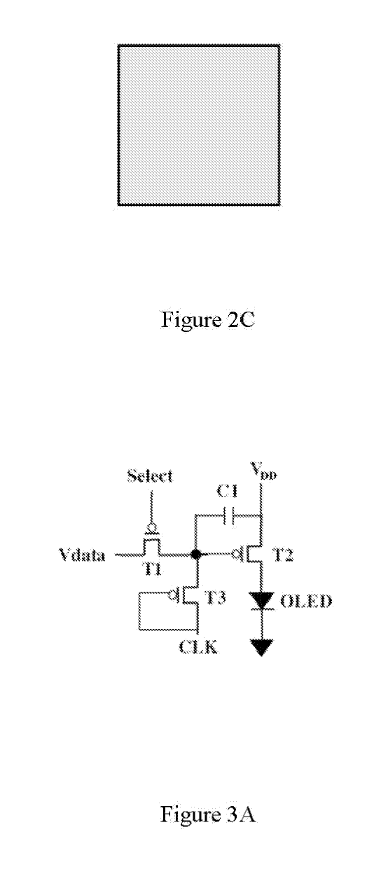

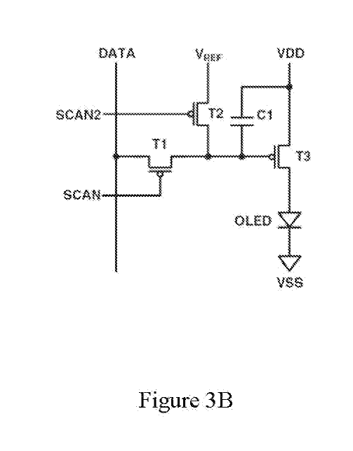

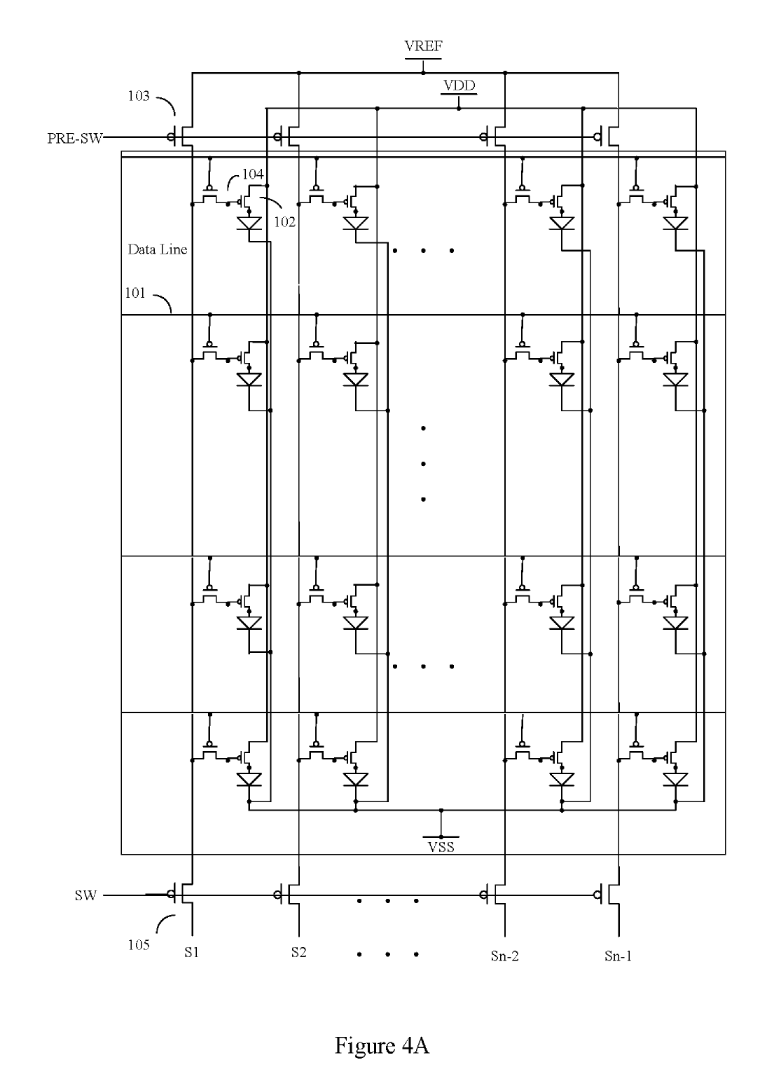

### DETAILED DESCRIPTION

In an embodiment of the present invention, a scanning line outputs a scanning voltage and turns on a switching TFT by scanning a pixel unit array from line to line; a resetting TFT transmits a received resetting signal to the switching TFT; the switching TFT transmits the received resetting signal to a driving TFT; a multiplexing TFT transmits a received data voltage signal to the switching TFT; the switching TFT transmits the received data voltage signal to the driving TFT; and the driving TFT drives an OLED. A uniform voltage is input to a gate of the driving TFT by the resetting signal, which ensures the voltage to vary in the same direction each time the data voltage signal is written to the gate of the driving TFT, and avoids the occurrence of the residual image due to the hysteresis effect of the TFT.

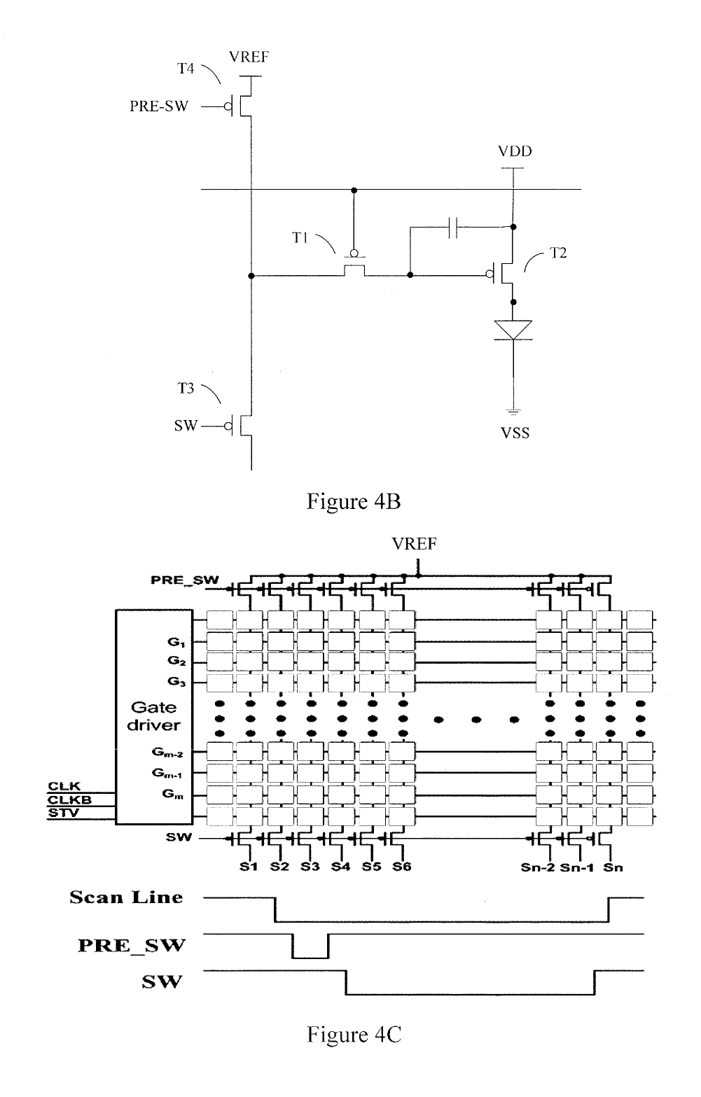

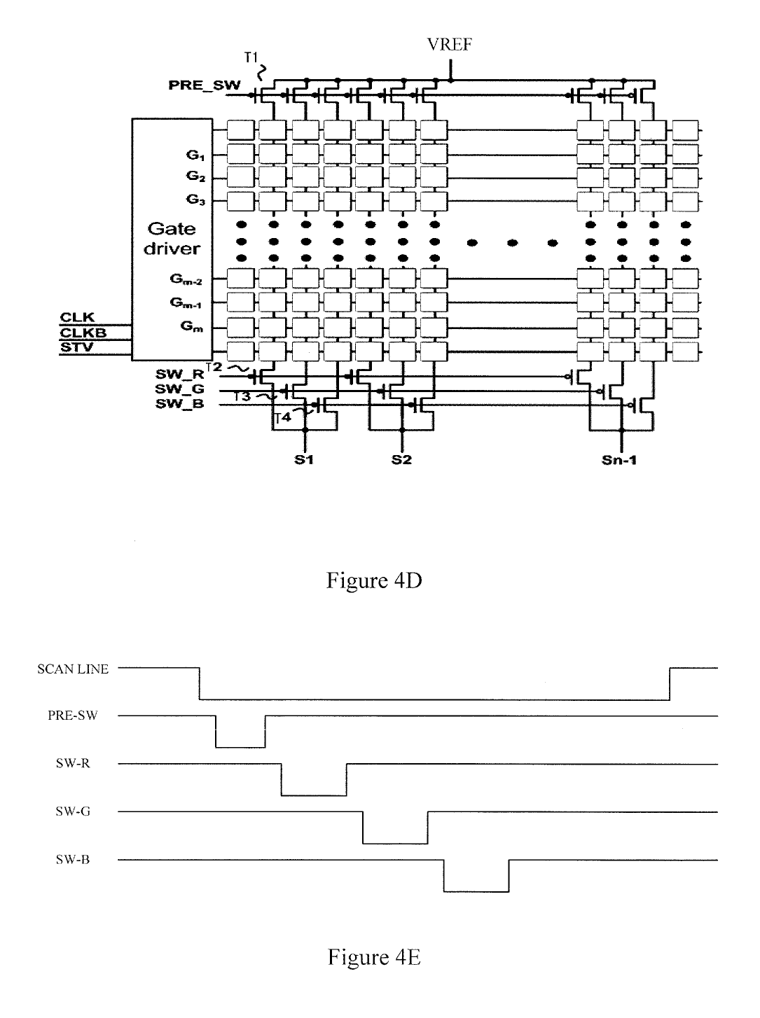

With reference to FIG. 4A, an OLED panel in an embodiment of the present invention includes a substrate and a pixel unit array formed thereon, wherein the pixel unit array comprises a plurality of pixel units defined by the intersections of scanning lines 101 and data lines. Each of the pixel units includes a driving TFT 102 and an OLED, and the driving TFT 102 has a source connected to a high voltage signal terminal in a backboard, and a drain connected to an anode of the OLED. Resetting TFTs 103 are arranged in the peripheral area of the pixel unit array on the substrate. Each of the pixel unit further includes a switching TFT 104, and multiplexing TFTs 105 are further arranged in the peripheral area of the pixel unit array on the substrate. In FIG. 4A, only the components in one pixel unit are indicated by signs, and the remaining pixel units are identical with said one pixel unit and thus those components therein are not indicated.

The scanning line 101 is used for outputting a scanning voltage, and turns on the switching TFT 104 by scanning the pixel unit array from line to line. The switching TFT 104 has a gate connected to the scanning line 101, a source connected to the data line, and a drain connected to the gate of the driving TFT 102. In an embodiment of the present invention, for example, all TFTs are of P channel enhancement type as an example. By adopting a progressive scanning mode, when an output signal at the scanning line 101, i.e., the voltage signal at the scanning line 101 is an active signal, in an embodiment of the present invention, is at a low level, the switching TFT 104 turns on so as to transmit the resetting signal received from the resetting TFT 103 or the output signal of the source output received from the multiplexing TFT 105, that is, an external data voltage signal, to the driving TFT 102.

The driving TFT 102 is used for driving the OLED, and the driving TFT 102 has a gate connected to the drain of the switching TFT 104, a source connected to the high voltage signal terminal in the backboard, and a drain connected to the anode of the OLED, wherein the high voltage signal in the backboard can be denoted as VDD. An equivalent circuit of a signal pixel unit is illustrated in FIG. 4B. The switching TFF 104, i.e., the FET T1 in the Figure has a gate connected to a scanning line 101, a source connected to a data line, and a drain connected to the gate of the driving TFT 102, i.e., of the FET T2 in the Figure. The FET T2 has a gate connected to the drain of the FET T1, a source connected to the high voltage signal terminal in the backboard, and a drain connected to the anode of the OLED. The issue of residual image due to the hysteresis effect can be effectively addressed by the embodiments of the present invention. In the embodiments of the present invention, only a few of the resetting transistors are added in the design of the pixel unit array, which has a limited influence on the area occupied by the circuit, and compared to the prior art, having advantages of a reduced aperture ratio, a low cost, low power consumption, and a simple manufacturing process.

The resetting TFT 103 is used for transmitting a resetting signal to the switching TFT 104. The resetting TFT 103 has a gate connected to a pre-controlling signal terminal, a source connected to a resetting signal terminal VREF, and a drain connected to a data line, wherein each resetting TFT 103 corresponds to the data line one-to-one. In an embodiment of the present invention, the data line is perpendicular to the scanning line 101, and a column of pixel units in a pixel unit array; that is, the pixel units in a pixel unit array connected to a data line can correspond to a resetting TFT 103, thus saving the number of the components in the circuit and reducing the area occupied by the pixel unit array. The gates of all the resetting TFTs 103 in a pixel unit array can be connected to a pre-controlling signal terminal, wherein the pre-controlling signal is denoted by PRE-SW. As a drain of a TFT is equivalent to a source thereof, the drain of each TFT and the source thereof in the embodiments of the present invention are not specifically indicated in the attached drawings. In an equivalent circuit of a single pixel unit as illustrated in FIG. 4B, when the PRE-SW is an active signal, that is, when PRE-SW is at a low level in the embodiment of the present invention, the resetting TFT 103, i.e., the T4 in FIG. 4B turns on and transmits the received resetting signal VREF to the switching TFT 104 (i.e., the FET T1 in FIG. 4B) via the date line, and then transmits the same to the gate of the driving TFT 102 (i.e., the gate of the FET T2) via the FET T1, so as to pre-input a voltage signal to the gate of FET T2. The FET T2 has a source connected to the high voltage signal terminal in a backboard, and a drain connected to the anode of the OLED; a cathode of the OLED is connected to a voltage signal terminal VSS, wherein the VSS voltage can be a grounding voltage, or a negative voltage. Upon completing the pre-input of voltage signal to the driving TFT 102, the resetting TFT 103 can be switched off, that is, the PRE-SW signal changes to a high level signal to avoid the occurrence of the competition. Preferably, the resetting signal can be lower or equal to the low level signal of the minimum level at the data line, or can be larger or equal to the high level signal of the maximum level at the data line. The gates of all the resetting TFTs 103 in a pixel unit array can be connected to the same pre-controlling signal terminal, and are controlled by the same pre-controlling signal PRE-SW, so as to ensure the voltage varies in the same direction each time a data voltage signal is written to the gate of the driving TFT 102. For instance, the input voltage of the gate of the driving TFT 102 ranges from 0 to 5V, if initially a 0V voltage is pre-input to the gate of the driving TFT 102, the voltage would change in a positive direction whatever the re-input voltage is; to the contrary, if initially a 5V voltage is pre-input to the gate of the driving TFT 102, then the voltage would vary in a negative direction whatever the input voltage is, thus improving the hysteresis effect of the TFT. The resetting TFTs 103 can locate on the top of the panel, that is, the resetting TFTs 103 and the source outputting module 103 locate on opposite sides of the panel respectively; the resetting TFTs 103 can also locate on the bottom of the panel, that is, the resetting TFTs 103 and the multiplexing TFTs 105 locate on the same side of the panel. Preferably, the resetting TFTs 103 can be arranged on the top of the panel, that is, the resetting TFTs and the multiplexing TFTs 105 locate at opposite sides of the panel; and data lines extend from the top of the panel to the bottom of the panel, that is, the resetting TFTs 103 and the multiplexing TFTs 105 equivalently locate at opposite ends of the data lines, and thus it needs not to occupy the area for wiring the data lines at the bottom of the panel, and can reduce the crosstalk of the control signals.

The switching TFT 104 is used for transmitting the received signal to the driving TFT 102. The switching TFT 104 has a gate connected to a scanning line 101, a source connected to a data line, and a drain connected to the gate of the driving TFT 102. The switching TFT 104 provides the driving TFT 101 with a pre-input voltage signal or a data voltage signal, wherein the data voltage signal is used for driving the OLED, thus driving the pixel unit array.

The multiplexing TFT 105 is used for transmitting the received data voltage signal to the switching TFT 104. In particular, in the embodiment of the present invention, the data voltage signal received by the multiplexing TFT 105 can be the signal output from the source output. The multiplexing TFT 105 has a gate connected to a gate controlling signal terminal, a source connected to a data voltage signal terminal, and a drain connected to a data line, wherein the gate controlling signal can be denoted as SW. The gate of each multiplexing TFT 105 is connected to a gate controlling signal terminal, and the gate controlling signal can be denoted as SW. If different multiplexing TFTs 105 are connected to different gate controlling signal terminals, the different gate controlling signal terminals can be denoted as SW-R, SW-G, SW-B and the like, respectively. The different output signals of a plurality of source outputs, i.e., a plurality of data voltage signals, can be denoted as S₁˜Sₙ₋₁. FIG. 4C shows a pixel unit array and a timing chart thereof when the data lines of the panel are equal to the data voltage signal terminals, that is, when the data lines of the panel is equal to the output signal terminals provided by the source outputs in number. When the resetting TFT 103 pre-inputs a voltage signal to the driving TFT 101, the multiplexing TFT 105 switches off; that is, the gate controlling signal SW is an inactive signal, i.e. in the embodiment of the present invention, the gate controlling signal SW is at a high level, thus avoiding the occurrence of the competition. After the resetting TFT 103 switches off, the gate controlling signal SW changes to a low level, and the multiplexing TFT 105 turns on; the output signal of the source output, i.e., the data voltage signal that is applied to the data line via the multiplexing TFT 105, is transmitted to the source of the switching TFT 104 via the data line, and then transmitted to the gate of the driving TFT 102 via the drain of the switching TFT 104, thus inputting a data voltage signal to the gate of the driving TFT 102, wherein the driving TFT 102 converts the data voltage signal to a current signal to drive the OLED, so as to realize the driving for the pixel unit array. The PRED-SW and SW can not be at a low level simultaneously to prevent the writing conflict. There can be a plurality of the source outputs for outputting different data voltage signals so as to provide the OLED with different currents and in turn allow the OLED to display different luminance. For the panel with medium or large size, generally, the number of the data lines of the panel is more than the number of the output signal lines which can be provided by the source outputs, and thus one end of the data line is connected to the output signal of the source output via the multiplexer, the other end of the data line is connected to the drain of the resetting TFT 103 and the source of the switching TFT 104. A multiplexer is composed of n multiplexing TFTs 105, and connected to the output signal terminal of the source output (i.e., the data voltage signal terminal) and the data line, wherein the n in a pixel unit array does not exceed the number of the multiplexing TFTs 105 included in the pixel unit array. In an embodiment of the present invention, taking the multiplexer MUX with 3:1 as an example, i.e., n=3, as shown in FIG. 4D, in a pixel unit array where the data lines of the panel are not equal to the data voltage signal terminals in number, that is, not equal to the output signal terminals provided by the source outputs in number, every three data lines are connected to an output terminal of the source output via three multiplexing TFTs 105, and the gates of the three multiplexing TFTs 105 are connected to different gate controlling signal terminals respectively, wherein the gate controlling signals can be denoted as SW-R, SW-G, SW-B and are under the control of different clocks so as to achieve the driving for each data line by the time-sharing driving mode.

FIG. 4E shows the timing chart for controlling the pixel circuit after the MUX multiplexer is employed, wherein SW-R, SW-G, SW-B are three gate controlling signals respectively. With reference to FIGS. 4D and 4E, firstly, when the scanning lines 101 changes to a low level, the switching TFT 104 turns on, and PRE-SW changes to a low level signal (wherein, it can be preset that when the signals of PRE-SW, SW-R, SW-G, SW-B and the like are at a high level or a low level); the resetting TFT 103, i.e., the FET T1 in the figure turns on, and the resetting signal VREF is transmitted to the switching TFT 104 via the data line, and in turn transmitted to the gate of the driving TFT 101 via the switching TFT 104. In an embodiment of the present invention, a low level signal is pre-input to the gate of the driving TFT 102 through the resetting signal terminal by the resetting signal VREF. During the procedure of pre-inputting a low level signal to the driving TFT 102 by the resetting TFT 103, the gate controlling signal of each multiplexing TFT 105, i.e., the respective gate controlling signals SW-R, SW-G, SW-B of the multiplexer are at high level, and the respective multiplexing TFTs 105 constituting the multiplexer keep in a switch-off state. After completing the pre-input of a low level signal to the driving TFT 102, the pre-controlling signal PRE-SW changes to a high level signal, and the resetting TFT 103 switches off; the gate controlling signal SW-R of the multiplexing TFT 105, i.e., of the FET T2 in the figure changes to a low level signal, and the output signal of the source output, i.e., the data voltage signal Sᵢ is transmitted to the source of the switching TFT 104 via the FET 12, and in turn transmitted to the gate of the driving TFT 102 via the drain of the switching TFT 104, and thus a data voltage signal is input to the gate of the driving TFT 102 and the driving for a column of pixel units is realized. Next, SW-G, SW-B change to a low level in turns, and the same procedure as that in which the SW-R changes to a low level is repeated, and thus the other two columns of pixel units are driven. At this time, the every three columns of the pixel units in a pixel unit array can be regarded as a combination, and the gate of the first multiplexing TFT 105 in a combination is controlled by SW-R, the gate of the second multiplexing TFT 105 in the combination is controlled by SW-G, and the gate of the third multiplexing TFT 105 in the combination is controlled by SW-B, and thus all the pixel units are driven in a time-sharing mode. It is prohibited that PRE-SW and any one of the gate controlling signals SW-R, SW-G, SW-B in a multiplexer are in a low level state simultaneously, avoiding the voltage conflict due to the occurrence of the repeat writing phenomenon. During one period for driving, the scanning line 101 keeps in a low level state; after the one period for driving ends, the scanning line 101 changes to a high level. When the scanning lines changes to a low level again, next period for driving begins.

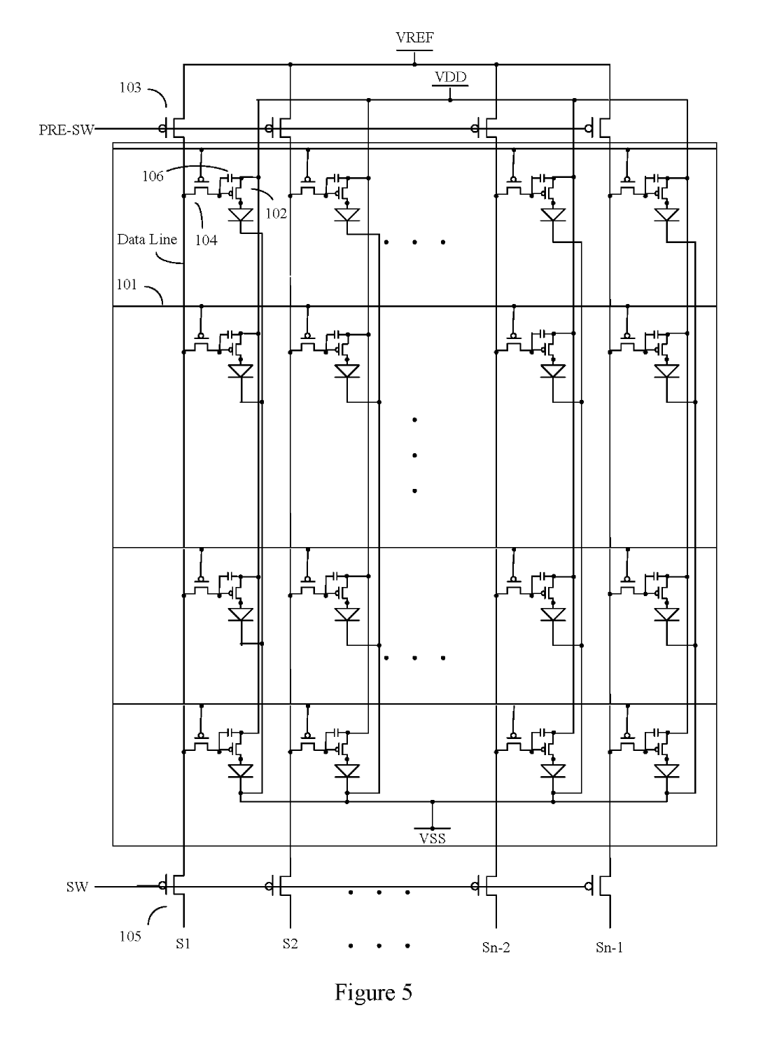

With reference to FIG. 5, each of pixel units on the OLED panel further comprises a storage capacitor 106.

The storage capacitor 106 is used for maintaining the gate voltage of the driving TFT 102. The storage capacitor 106 is connected between the gate of the driving TFT 102 and the source thereof, for maintaining the gate voltage of the driving TFT 102.

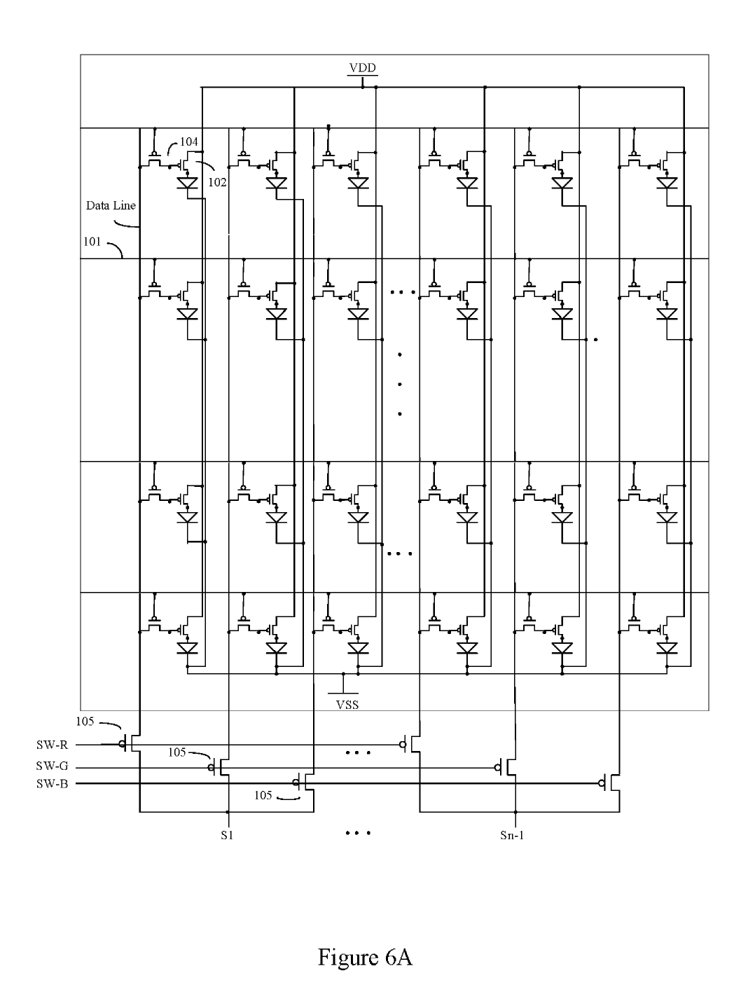

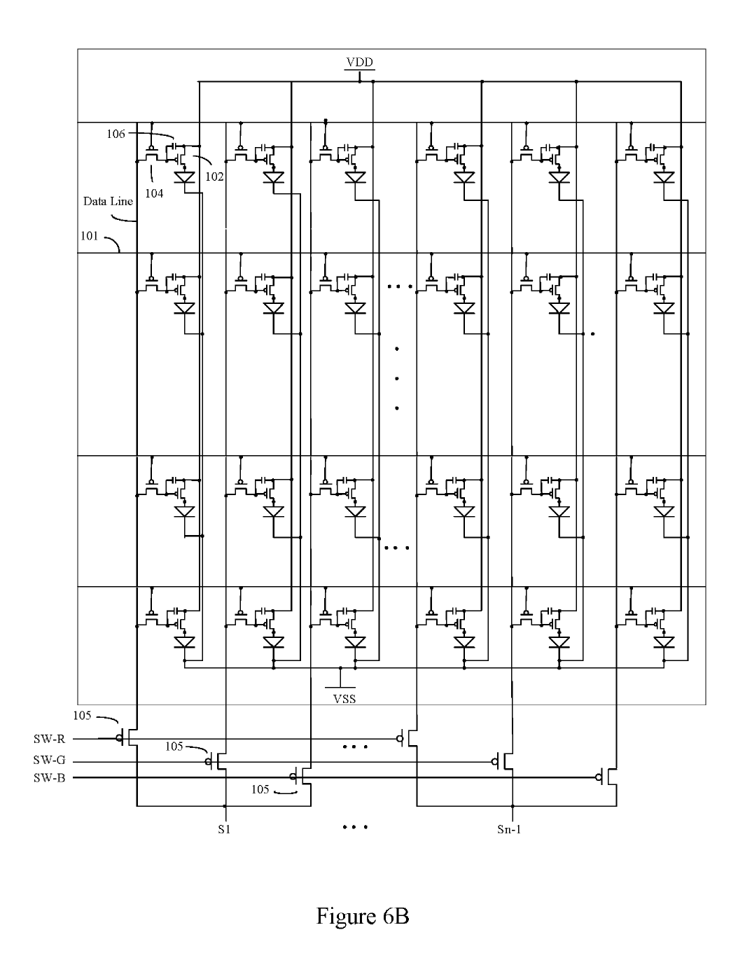

With reference to FIG. 6A, an embodiment of the present invention further provides another OLED panel comprising a substrate and a pixel unit array formed thereon, wherein the pixel unit array comprises pixel units defined by the intersections of scanning lines 101 and data lines. Each of the pixel units includes a driving TFT 102 and an OLED, and the driving TFT 102 has a source connected to a high voltage signal terminal in a backboard, and a drain connected to an anode of the OLED. A plurality of multiplexing TFTs 105 are arranged in the peripheral area of the pixel unit array on the substrate, and every n multiplexing TFTs 105 constitute a multiplexer, and the multiplexer is connected to the data voltage signal terminal and the data lines; wherein, the sources of n multiplexing TFT 105 are connected, the drains thereof are connected to different data lines respectively, and the gates thereof are connected to different gate controlling signal terminals; n does not exceed the number of the multiplexing TFTs 105 included in the pixel unit array. The OLED panel further includes the switching TFTs 104.

The scanning line 101 is used for turning on the switching TFT 104 by scanning the pixel unit array from line to line. When a voltage signal at the scanning line 101 is at low level, the switching TFT 104 turns on so as to transmit the resetting signal or the data voltage signal to the driving TFT 102.

The driving TFT 102 is used for driving the OLED, thus driving the pixel circuit. The driving TFT 102 has a gate connected to the drain of the switching TFT 104, a source connected to the high voltage signal terminal in the backboard, and a drain connected to the anode of the OLED.

The switching TFF 104 is used for transmitting the received signal to the driving TFT 102. The switching TFT 104 has a gate connected to a scan line, a source connected to a data line, and a drain connected to the gate of the driving TFT 102. The switching TFT 104 provides the driving TFT 102 with a data voltage signal, wherein the data voltage signal is used for driving the OLED, thus driving the pixel unit array.

The multiplexing TFT 105 is used for transmitting the received data voltage signal to the switching TFT 104. Every n multiplexing TFTs 105 constitute a multiplexer, and the multiplexer is connected to the data voltage signal terminal and the data lines respectively; wherein, the sources of n multiplexing TFTs 105 are connected and further connected to the data voltage signal terminal, the drains thereof are connected to different data lines respectively, and the gates thereof are connected to different gate controlling signal terminals; n does not exceed the number of the multiplexing TFTs 105 included in the pixel unit array. In an embodiment of the present invention, taking the multiplexer MUX with 3:1 as an example, i.e., n=3, as shown in FIG. 6B, in a pixel unit array, every three data lines are connected to an output terminal of the source output(S₁, . . . , Sₙ₋₁) via three multiplexing TFTs 105, and the gates of the three multiplexing TFTs 105 are connected to different gate controlling signal terminal, wherein the gate controlling signals can be denoted as SW-R, SW-G, and SW-B. After the voltage signal at the scanning line 101 changes to a low level signal, SW-R, SW-G, and SW-B change to a low level simultaneously, and the data voltage signal is controlled to be at a low level or at a high level, then the low level or high level of the source output is transmitted to the pixel unit array via the data line, thus driving the OLED by the driving TFT 102.

With reference to FIG. 6B, each of pixel units on the OLED panel further comprises a storage capacitor 106.

The storage capacitor 106 is used for maintaining the gate voltage of the driving TFT 102. The storage capacitor 106 is connected between the gate of the driving TFT 102 and the source thereof, for maintaining the gate voltage of the driving TFT 102.

According to the embodiment of the present invention, it can realize the driving for the pixel circuit without the resetting TFT 103 and without adding an extra circuit, and can avoid the occurrence of the hysteresis effect of the TFT, and has advantages of low cost, low power consumption, and simple implementation. The embodiment of the present invention needs to generate four voltage signals in one period, and needs to control the output voltage of the source output.

The method for driving the OLED panel is introduced by the implementing flow.

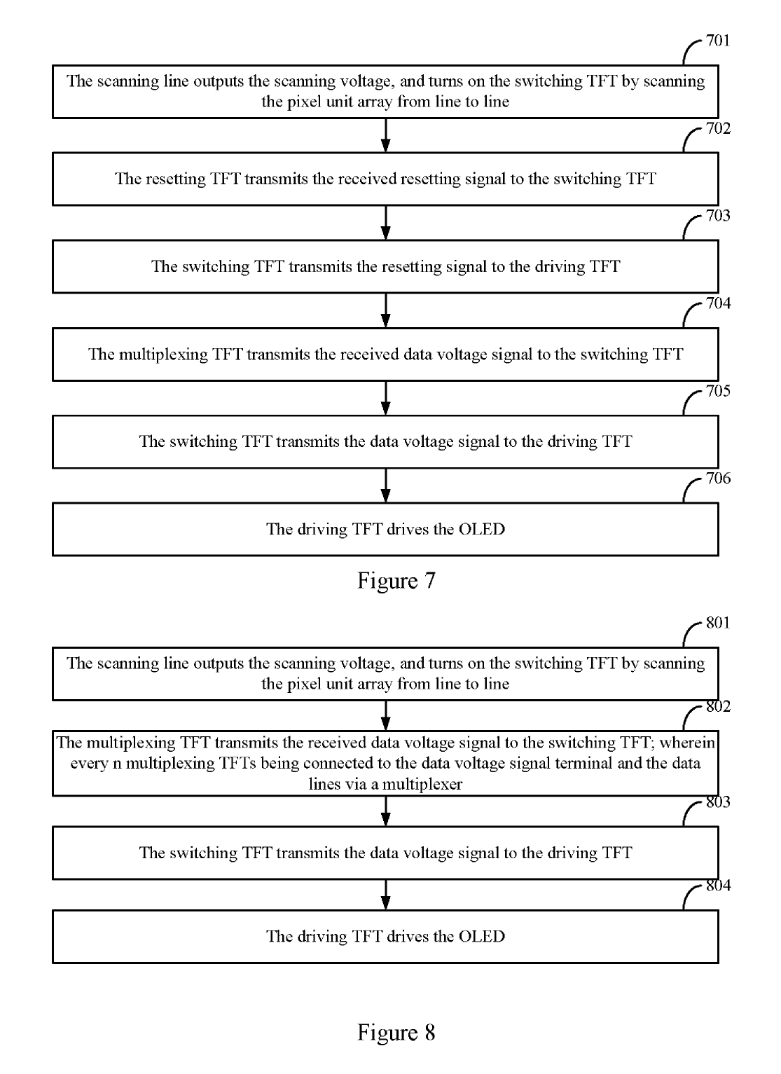

With reference to FIG. 7, the main flow of the method for driving the OLED panel in the embodiment of the present invention is as follows:

Step 701: the scanning line 101 outputs the scanning voltage, and turns on the switching TFT 104 by scanning the pixel unit array from line to line.

Step 702: the resetting TFT 103 transmits the received resetting signal to the switching TFT 104.

Step 703: the switching TFT 104 transmits the resetting signal to the driving TFT 102.

Step 704: the multiplexing TFT 105 transmits the received data voltage signal to the switching TFT 104.

Step 705: the switching TFT 104 transmits the data voltage signal to the driving TFT 102.

Step 706: the driving TFT 102 drives the OLED.

The detailed flow of the method for driving the OLED panel in the embodiment of the present invention is as follows:

The scanning line 101 changes to a low level, and the switching TFT 104 turns on; PRE-SW signal changes to a low level, the resetting TFT 103 turns on, and in the meantime, SW signal changes to a high level, and the multiplexing TFT 105 switches off; SW signal changes to a low level, the multiplexing TFT 105 turns on, and in the meantime PRE-SW signal changes to a high level, and the resetting TFT 103 switches off; the switching TFT 104 transmits the output signal of the source output, i.e., the data voltage signal to the driving TFT 102, and the driving TFT 102 drives the OLED.

During the driving procedure of one period, the scanning line 101 maintains at a low level; after one cycle of scanning ends, the scanning line 101 changes to a high level. When the scanning line 101 changes to a low level again, next cycle of scanning starts, repeating the same steps as those in the present embodiment.

With reference to FIG. 8, the main flow of the method for driving another OLED panel in an embodiment of the present invention is as follows:

Step 801: the scanning line 101 outputs the scanning voltage, and turns on the switching TFT 104 by scanning the pixel unit array from line to line.

Step 802: the multiplexing TFT 105 transmits the received data voltage signal to the switching TFT 104; wherein every n multiplexing TFTs 105 constitute a multiplexer, and the multiplexer is connected to the data voltage signal terminal and the data lines; wherein, the sources of n multiplexing TFTs 105 are connected, the drains thereof are connected to different data lines respectively, and the gates thereof are connected to different gate controlling signal terminals; n does not exceed the number of the multiplexing TFTs 105 included in the pixel unit array.

Step 803: the switching TFT 104 transmits the data voltage signal to the driving TFT 102.

Step 804: the driving TFT 102 drives the OLED.

The detailed flow of the method for driving another OLED panel in an embodiment of the present invention is as follows:

When the scanning 101 changes to a low level, the switching TFT 104 turns on; the multiplexing TFT 105 transmits a data voltage signal to the switching TFT 104. After the switching TFT 104 turns on, SW-R, SW-G, and SW-B change to a low level simultaneously, and the three multiplexing TFTs 105 connected to a MUX turn on at the same time; in the meantime, the data voltage signal is at a low level or a high level, wherein the data voltage signal can be the output signal of the source output. The output signal of the source output is transmitted to the driving TFT 102 via the switching TFT 104 to drive the OLED. In the embodiment of the present invention, what is used is a MUX multiplexer, and the gate controlling signals are respectively SW-R, SW-G and SW-B.

In an embodiment of the present invention, the scanning line 101 outputs the scanning voltage, and turns on the switching TFT 104 by scanning the pixel unit array from line to line; the resetting TFT 103 transmits a received resetting signal to the switching TFT 104; the switching TFT 104 transmits the received resetting signal to the driving TFT 102; the multiplexing TFT 105 transmits the received data voltage signal to the switching TFT 104; the switching TFT 104 transmits the data voltage signal to the driving TFT 102; and the driving TFT 102 drives the OLED. A uniform voltage is input to the gate of the driving TFT 102 by the resetting signal terminal, which ensures the voltage to vary in the same direction each time the data voltage signal is written to the gate of the driving TFT 102, and avoids the occurrence of the residual image due to the hysteresis effect of the TFT. Only a few of the resetting TFTs 103 are added, and these resetting TFTs 103 can be arranged on the top of the panel, thus not occupying the wiring resource on the bottom of the panel and reducing the crosstalk of the control signals. The addition of the few resetting TFTs 103 has a limited influence on the area occupied by the whole pixel unit array; compared to the prior art, the affect on the aperture ratio is decreased, achieving a low cost, low power consumption, and simple manufacturing process. The embodiment of the present invention further provides a method for driving the OLED panel, comprising the steps of: the scanning line 101 outputs the scanning voltage, and turns on the switching TFT 104 by scanning the pixel unit array from line to line; the multiplexing TFT 105 transmits the received data voltage signal to the switching TFT 104; wherein every n multiplexing TFTs 105 constitute a multiplexer, and the multiplexer is connected to the data voltage signal terminal and the data lines; wherein, the sources of n multiplexing TFTs 105 are connected, the drains thereof are connected to different data lines respectively, and the gates thereof are connected to different gate controlling signal terminals; n does not exceed the number of the multiplexing TFTs 105 included in the pixel unit array; the switching TFT 104 transmits the data voltage signal to the driving TFT 102; and the driving TFT 102 drives the OLED. Without the resetting TFT 103, the driving for the pixel unit array, i.e., the driving for the OLED panel, is implemented by controlling the timing of the multiplexer and the output voltage of the source output without adding extra components, thus effectively improving the issue of residual image due to the hysteresis effect of the TFT. The embodiments of the present invention have advantages of a simple implementation, low cost, and low power consumption.

Apparently, those skilled in the art can make various modifications and variations on the present invention without departing from the spirit and scope of the present invention. Thus, if these modifications and variations belong to the scopes of the claims of the invention and the equivalents thereof, the present invention intends to cover such modifications and variations.

1. An Organic Light-Emitting Diode (OLED) panel, including a substrate and a pixel unit array formed thereon, wherein the pixel unit array comprises scanning lines, data lines and pixel units, and each of the pixel units includes a driving Thin Film Transistor (TFT) and an OLED, and the driving TFT has a source connected to a high voltage signal terminal in a backboard, and a drain connected to an anode of the OLED, wherein the pixel unit further includes resetting TFTs and multiplexing TFTs, the resetting TFT has a gate connected a pre-controlling signal terminal and a source connected to a resetting signal terminal, and each resetting TFT corresponds to the data line one-to-one, and the multiplexing TFT has a gate connected to a gate controlling signal terminal, a source connected to a data voltage signal terminal, and a drain connected to the data line.

2. The OLED panel of claim 1, wherein, each of the pixel units further includes a switching TFT and a storage capacitor, wherein the switching TFT has a gate connected to the scan line, a source connected to the data line, and the drain connected to the gate of the driving TFT; the two ends of the capacitor are connected to the source and the gate of the driving TFT respectively.

3. The OLED panel of claim 1, wherein, multiplexing TFTs is further arranged in the peripheral area of the pixel unit array on the substrate, and the multiplexing TFT has a gate connected to a gate controlling signal terminal, a source connected to a data voltage signal terminal, and a drain connected to the data line.

4. The OLED panel of claim 3, wherein, every n multiplexing TFTs constitute a multiplexer, and the multiplexer is connected to the data voltage signal terminal and the data line; wherein, the sources of n multiplexing TFTs are connected, the drains thereof are connected to different data lines respectively, and the gates thereof are connected to different gate controlling signal terminals; n does not exceed the number of the multiplexing TFTs included in the pixel unit array.

5. The OLED panel of claim 3, wherein, a plurality of the pixel units share a resetting TFT and a multiplexing TFT.

6. The OLED panel of claim 5, wherein, the resetting TFT and the multiplexing TFT locate at the opposite ends of the data line.

7. A method for driving an OLED panel, wherein the method comprises the steps of:
outputting scanning voltage and turning on the switching TFT by scanning the pixel unit array from line to line by the scanning line;
transmitting a received resetting signal to the switching TFT by the resetting TFT;
transmitting the received resetting signal to the driving TFT by the switching TFT;
transmitting a received data voltage signal to the switching TFT by the multiplexing TFT;
transmitting the received data voltage signal to the driving TFT by the switching TFT; and
driving the OLED by the driving TFT.

8. The method for driving the OLED panel of claim 7, wherein, prior to the step of transmitting the received resetting signal to the switching TFT by the resetting TFT, the method further comprises the steps of outputting an active signal to a pre-controlling signal terminal connected to the gate of the resetting TFT to turn on the resetting TFT, and outputting an inactive signal to a gate controlling signal terminal connected to the gate of the multiplexing TFT to turn off the multiplexing TFT.

9. The method for driving the OLED panel of claim 7, wherein, prior to the step of transmitting the received data voltage signal to the switching TFT by the multiplexing TFT, the method further comprises the steps of outputting an active signal to a gate controlling signal terminal connected to the gate of the multiplexing TFT to turn on the multiplexing TFT, and outputting an inactive signal to a pre-controlling signal terminal connected to the gate of the resetting TFT to turn off the resetting TFT.

10. The method for driving the OLED panel of claim 7, wherein, every n multiplexing TFTs constitute a multiplexer, and the multiplexer is connected to the data voltage signal terminal and the data line respectively, wherein n does not exceed the number of the multiplexing TFTs included in the pixel unit array;
prior to the step of transmitting the received data voltage signal to the switching TFT by the multiplexing TFT, the method further comprises the steps of outputting an active signal to gate controlling signal terminals connected to the gates of a plurality of multiplexing TFTs constituting a multiplexer to turn on the plurality of multiplexing TFTs sequentially.

11. An OLED panel comprising a substrate and a pixel unit array formed thereon, wherein the pixel unit array comprises pixel units defined by the intersections of scanning lines and data lines, and each of the pixel units includes a driving Thin Film Transistor TFT and an OLED, and the driving TFT has a source connected to a high voltage signal terminal in a backboard, a drain connected to an anode of the OLED; wherein, the each of the pixel units further includes multiplexing TFTs, wherein every n multiplexing TFTs constitute a multiplexer, and the multiplexer is connected to the data voltage signal terminal and the data lines respectively; wherein, the sources of n multiplexing TFTs are connected, the drains thereof are connected to different data lines respectively, and the gates thereof are connected to different gate controlling signal terminals; n does not exceed the number of the multiplexing TFTs included in the pixel unit array.

12. The OLED panel of claim 11, wherein, each of the pixel units further includes a switching TFT and a storage capacitor, wherein the switching TFT has a gate connected to the scan line, a source connected to the data line, and the drain connected to the gate of the driving TFT; the two ends of the storage capacitor are connected to the source and the gate of the driving TFT respectively.
